(19) United States
(12) Patent Application Publication
(10) Pub. No.: US 2023/0341021 A1
(43) Pub. Date: Oct. 26, 2023

(54) Composite Wave Springs

(71) Applicant: Arris Composites Inc., Berkeley, CA (US)

(72) Inventors: Olivier D′AMOURS-ROUSSEAU, Davis, CA (US); Erick DAVIDSON, Piedmont, CA (US); Jalen MANO, Oakland, CA (US)

(21) Appl. No.: 18/138,271

(22) Filed: Apr. 24, 2023

Related U.S. Application Data
(60) Provisional application No. 63/334,325, filed on Apr. 25, 2022.

(51) Int. Cl. F16F 1/371; F16F 3/087; F16F 1/366

(52) U.S. Cl. CPC F16F 3/0876; F16F 1/366; F16F 1/371; F16F 2224/005; F16F 2224/0241; F16F 2234/06

(57) ABSTRACT

A wave spring comprises fiber in a thermoplastic resin matrix, and includes one or more annular wave-springs elements, or one or more curvilinear wave-spring elements. The annular wave-spring elements, which are arrayed in a stack, are not coupled to one another. A wave spring comprising annular wave-spring elements includes an alignment feature for establishing and maintaining the alignment of the wave spring elements. In a wave spring including curvilinear wave-spring elements, a first end of each curvilinear wave-spring element is attached to a first member and a second end of each curvilinear wave-spring element is attached to a second member, the plurality of curvilinear wave-spring elements being disposed between the two members. The plurality of curvilinear wave-spring elements in the array are positioned side by side, the array extending laterally along a length of the first member and second member, and providing a low-profile wave spring.

### STATEMENT OF RELATED CASES

This case claim priority of US 63/334,325 filed Apr. 25, 2022, and incorporated by reference herein.

### FIELD OF THE INVENTION

The present invention pertains to fiber-composite springs.

### BACKGROUND OF THE INVENTION

Composite materials, which have fibers embedded in a supporting matrix material, are used for fabricating strong, lightweight parts. These composites have an attractive combination of properties, and provide significant manufacturing, performance, and economic advantages.

One technology area that has benefitted comparatively little from the use of advanced-composites is spring design. Springs, which find many applications, come in a variety of forms, such as coil springs, Belleville springs, leaf springs, gas/air springs, wave springs, and others.

Coil springs are quite common; they are easy to manufacture and find uses in almost any application where springs are needed. However, coil springs are usually made of metal, which makes them relatively heavy. Also, due to their construction, coil springs store/release energy torsionally, twisting as they compress. Consequently, not all force is axially aligned, and undesirable loads may be transferred to surrounding hardware.

Applying composites technology to coil springs is problematic; a composite coil spring requires very complex fiber orientations to resist not only bending, but also torsion. In addition to being complicated to design, the helical shape of a coil spring is particularly difficult to demold. Accordingly, the usual manufacturing and economic advantages accruing from the use of composites are not realized when applied to composite coil springs.

### SUMMARY

The present invention provides a fiber-composite spring that addresses some of the shortcomings of the prior art.

Some embodiments of the invention provide a wave spring made from fiber-composite material. A wave spring provides the same functionality as a coil spring. However, while coil springs rely on torsion, a wave spring stores and releases energy by bending. Specifically, as a load is applied, portions of the wave spring flatten, providing an upward force, enabling full axial-load transmission.

As compared to its metal counterpart, a fiber-composite wave spring in accordance with the present teachings is characterized by lighter weight and higher specific strength. In fact, a fiber-composite wave spring in accordance with embodiments of the invention is typically in the range of 40-80% lighter than a metal wave spring having similar spring characteristics.

Embodiments of a wave spring include: (i) those having one or more annular wave-springs elements and (ii) those having one or more curvilinear wave-spring elements.

Annular (but not necessarily circular) wave-spring elements vary in height around the annulus, the variation in height creating one or more “waves” in the element. In some embodiments, attributes of the annular wave-spring element may vary within the wave-spring element itself: for example, the thickness and/or shape, etc. of the cross section may vary along the annulus.

The annular wave-spring elements are stackable into a “vertical” array (although such a stack may be positioned horizontally), and embodiments of a wave spring may include a stack of one or more such annular wave-spring elements. In some embodiments of such embodiments, the design of the individual annular wave-spring-elements within the stack may vary from one another. This enables, for example, a progressive spring rate through the stroke of the spring. As an example, consider a spring that becomes stiffer as it is increasingly compressed. This characteristic can prevent a spring assembly from bottoming out, and transferring undesirably high impulse loads to any surrounding structure.

Similar benefits in spring rate and performance tuning can be achieved with a wave spring comprising a stack of annular wave-spring elements, wherein the individual annular wave-spring elements have different thicknesses in specific locations in the wave spring. Other aspects of each annular wave-spring element can be altered to change the performance of a wave spring incorporating such elements. For example, the thickness, cross-sectional profile, and/or materials composition (fiber type, resin type, fiber-volume-fraction) can be individually selected for any given annular wave-spring-element in a stack of such elements.

In accordance with the present teachings, within a stack of annular wave-spring elements, individual annular wave-spring elements are not rigidly coupled to one another. However, since the alignment of individual annular wave-spring elements within a stack affects spring characteristics, a desired alignment must be maintained. In various embodiments, such alignment is maintained through any one of a variety of structural “keying” arrangements.

In some further embodiments, inserts are placed between individual annular wave-spring elements. For example, in some of such embodiments, the inserts are positioned so that they prevent two annular wave-spring elements from displacing relative to one another once a certain amount of displacement is achieved. This increases the spring rate of the pair of elements, and again provides a progressive spring rate. In some embodiments, inserts are varied in thickness such that different annular wave-spring-element pairs reach the maximum displacement relative to one another at different points in their stroke, further providing tunability for the wave spring.

In some embodiments, external rings are used as spacers to limit the permissible displacement of an annular wave-spring element or a group of such elements before load is transferred to the external rings. When used in a nested arrangement consisting of, for example, three nested annular wave-spring elements that are stacked on top of two nested annular wave-spring elements, that are stacked on a single annular wave-spring element, these rings could prevent the single element from deflecting too far before the two- and three element groups begin to deflect and provide resistance.

In some embodiments, the invention provides a fiber-composite wave spring comprising a plurality of annular wave-spring elements arranged in an array, wherein each of the annular wave-spring elements consist essentially of aligned fibers in a thermoplastic resin matrix, and wherein: (a) the annular wave-spring elements are not rigidly coupled to one another; (b) the annular wave-spring elements are stacked one above another; and an alignment feature that aligns the wave-spring elements to one another.

In some other embodiments, the invention provides a fiber-composite wave spring comprising a plurality of curvilinear wave-spring elements arranged in an array, wherein each wave-spring elements consists essentially of aligned fibers in a thermoplastic resin matrix, and wherein: a first end of each curvilinear wave-spring element is attached to a first member and a second end of each curvilinear wave-spring element is attached to a second member, the plurality of curvilinear wave-spring elements being disposed between the two members; and the plurality of curvilinear wave-spring elements in the array are positioned side by side, the array extending laterally along a length of the first member and second member.

Additional embodiments in accordance with the present invention are provided in the drawings and the accompanying detailed description.

### BRIEF DESCRIPTION OF THE DRAWINGS

FIG. 1A through FIG. 1D depicts various views of an annular wave-spring element in accordance with an illustrative embodiment of the present invention.

FIG. 2 depicts a wave spring comprising a plurality of the annular wave-spring elements of FIGS. 1A through 1D.

FIG. 3 depicts an embodiment of an annular wave-spring element in which the thickness of the element varies with location along the annulus.

FIG. 4 depicts an embodiment of an annular wave-spring element wherein the width of the annulus varies with location along the annulus.

FIG. 5 depicts a plan view of a mold and assemblage of preforms that may be used to fabricate a wave spring in accordance with the present teachings.

FIGS. 6A and 6B depicts a first embodiment of features for aligning two or more annular wave-spring elements with respect to one another.

FIGS. 7A and 7B depicts a second embodiment of features for aligning two or more annular wave-spring elements with respect to one another.

FIGS. 8A and 8B depicts a third embodiment of features for aligning two or more annular wave-spring elements with respect to one another.

FIGS. 9A through 9C depict a fourth embodiment of features for aligning two or more annular wave-spring elements with respect to one another.

FIGS. 10A through 10E depict further embodiments of features for aligning two or more annular wave-spring elements with respect to one another.

FIG. 11 depicts an annular wave-spring element with a progressive spring rate.

FIG. 12 depicts a curvilinear wave-spring element in accordance with an illustrative embodiment of the present invention.

FIG. 13A depicts a wave spring comprising a lateral array of the curvilinear wave-spring elements of FIG. 12.

FIG. 13B depicts a stack of two of the wave springs of FIG. 13A.

### DETAILED DESCRIPTION

Definitions. The following terms are defined for use in this description and the appended claims:
“Fiber” means an individual strand of material. A fiber has a length that is much greater than its diameter.
“Fiber bundle” means plural (typically multiples of one thousand) unidirectional fibers.
“Stiffness” in the context of a material means resistance to bending, as measured by Young’s modulus. When used in the context of a spring or spring assembly, “stiffness” means resistance to displacement from an unstretched/uncompressed state.
“Tow” means a bundle of fibers (i.e., fiber bundle), and those terms are used interchangeably herein unless otherwise specified. Tows are typically available with fibers numbering in the thousands: a 1K tow, 4K tow, 8K tow, etc.
“Prepreg” means fibers that are impregnated with resin.
“Towpreg” means a fiber bundle (i.e., a tow) that is impregnated with resin.
“Preform” means a segment of plural, co-aligned, resin-impregnated, typically same-length fibers. The segment is cut to a specific length, and, at least initially, is linear/straight; however, in many cases, will be shaped (e.g., bent at one or more locations, twisted, etc.) to a specific form, as appropriate for the specific part being molded. Preforms are usually sourced from towpreg (i.e., the towpreg is sectioned to a desired length), but can also be from another source of plural co-aligned, unidirectionally aligned fibers (e.g., a resin impregnation process, etc.). Preforms are preferably, but not necessarily, substantially circular, or oval in cross section and have a filamentous form. That is, a form factor akin to a filament; that is, relatively long compared to its width, and having a typically circular or oval cross section. Applicant’s use of the term “preform” explicitly excludes groupings of fibers having a relatively “flat” form factor, such as (i) tape/ribbon, (ii) sheets of fiber, and (iii) mats/laminates, cut to shape or otherwise. The modifier “fiber-bundle” or “FB” may be pre-pended herein to the word “preform” to emphasize the nature of applicant’s preforms and to distinguish them from prior-art preforms, which are typically in the form of tape/ribbon, sheets, mats, laminates, or shapes cut therefrom.
“Preform Charge” means an arrangement of preforms that are at least loosely bound together (i.e., tacked) to maintain their position relative to one another. Preform charges are not fully consolidated (“excess” void space remains such that the preform charge will generally not meet the specifications for a finished part).
“Preform Layup” is an arrangement of preforms that is formed by placing the preforms, one-by-one, into a mold cavity. A preform “layup” is distinguished from a preform “charge,” wherein for the latter, the feed constituents are at least loosely bound to one another, and the preform charge is typically formed outside of the mold cavity.
“Assemblage of feed constituents” refers to either a preform charge, a preform layout, or a combination of both.
“Consolidate,” “consolidating,” or “consolidation” means, in the present context, that in a grouping of fibers/resin, such as plurality of preforms, void space is removed to the extent possible and as is acceptable for a final part. Feed structures lose any unique or individual identity and any previously existing boundaries between adjacent preforms are lost. This usually requires significantly elevated pressure, either via gas pressurization (or vacuum), or the mechanical application of force (e.g., rollers, etc.), and elevated temperature (to soften/melt the resin).
“Partial consolidation” means, in the present context, that in a grouping of fibers/resin, void space is not removed to the extent required for a final part. As an approximation, one to two orders of magnitude more pressure is required for full consolidation versus partial consolidation. As a further very rough generalization, to consolidate fiber composite material to about 80 percent of full consolidation requires only 20 percent of the pressure required to obtain full consolidation.
“Compression molding” is a molding process that involves the application of heat and pressure to feed constituents, such as a preform charge, preform layup, or a combination thereof. The feed constituents are typically placed in a female mold portion having a mold cavity. After the requisite amount of feed constituents are placed in the female mold half, a second mold half -a male mold half- is joined to the female mold half and the mold cavity is closed. The male mold half usually includes features (e.g., a plunger, etc.) that extend into the female male half to engage the feed constituents therein. For applicant’s processes, the applied pressure is usually in the range of about 500 psi to about 5000 psi, and temperature, which is a function of the resin being used, is typically in the range of about 150° C. to about 400° C. Once the applied heat has increased the temperature of the resin above its melt temperature, it is no longer solid and will flow. The resin will then conform to the mold geometry via the applied pressure, and the feed constituents are thereby consolidated, resulting in a nascent part with very little void space. Elevated pressure and temperature are typically maintained for a few minutes. After this compression molding protocol is complete, the mold is cooled. Once cooled, pressure is released, and a finished part is removed from the mold.
“Neat” resin or other matrix material means the resin/matrix material has no reinforcing fibers.
“Nested” means, when used to reference a relationship between two or more annular wave-spring elements, that a major surface of one annular wave-spring element is fully in contact with that of another annular wave-spring element. Annular wave-spring elements are typically nested; rather; surface contact between overlying/underlying annular wave-spring elements occurs at high and low points thereof.
“Compatible” means, when used in reference to two or more matrix materials, that the materials will mix and bond with each other.
Spring “rate” or “constant” refer to the force required to displace a spring by a certain length. For instance, a spring rate can be 500 lbs/in, meaning it would take 500 lbs to deflect the spring 1 inch, 1000 lbs to deflect the spring 2 inches, etc.
“Wave-spring element” is a structure that provides the same functionality as a coil spring; however, while coil springs rely on torsion, a wave spring stores and releases energy by bending. A wave-spring element has a variation in height, and as a load is applied to the element, the elevated portion(s) flatten, providing an “upward” force, enabling full axial-load transmission.
“Wave Spring” is a structure that includes one or more wave-spring elements.
“About” or “Substantially” means +/- 20% with respect to a stated figure or nominal value.
Other definitions may be provided elsewhere in this specification, in context. All patents and published patent applications referenced in this disclosure are incorporated by reference herein.

It is to be understood that any numerical range recited herein is intended to include all sub-ranges encompassed therein. For example, a range of “1 to 10” is intended to include all sub-ranges between (and including) the recited minimum value of about 1 and the recited maximum value of about 10, that is, having a minimum value equal to or greater than about 1 and a maximum value of equal to or less than about 10. As a non-limiting example, a recited range of “1 to 10 µm” includes “5 to 8 µm”, “1 to 4 µm”, “2 to 9 µm”, etc.

Some embodiments in accordance with the present teachings provide a fiber-composite wave spring comprising plural wave-spring elements.

In accordance with the present teachings, the wave-spring elements described herein are formed via a compression-molding process using fiber-composite feed constituents. In the illustrative embodiment, the feed constituents are a plurality of preforms. As part of the molding process, the preforms are arranged into an assemblage; either a preform charge or a lay-up. With the assemblage appropriately registered to the mold cavity, the preforms are positioned so that the preforms will be aligned with the anticipated in-use stress vectors that are expected to arise in the wave-spring elements when the wave spring is in use and under load. During compression molding, the assemblage of preforms are consolidated to form a final part; in this context, a wave-spring element.

Feed Constituents. As previously noted, a wave-spring element is formed from an assemblage of preforms. Preforms are typically formed from towpreg, but may also be sourced from the output of a resin impregnation line. To form a preform from towpreg or the output of a resin impregnation line, the towpreg is cut into segments of a desired size and often shaped (e.g., bent, etc.) as well. Each preform include thousands of co-aligned, resin-infused fibers, typically in multiples of one thousand (e.g., 1k, 10k, 24k, etc.). A preform may have any suitable cross-sectional shape (e.g., circular, oval, trilobal, polygonal, etc.), but is most typically substantially circular/oval.

As noted above, the preforms are organized into an assemblage. The assemblage has a geometry and shape that is close to that of the final structure, which in this case is a wave-spring element. In some embodiments, the preforms are placed one-by-one into the mold (i.e., a lay-up). In some other embodiments, the preforms are first organized into a “preform charge.”

A preform charge includes a plurality of preforms that are “tacked” together. The term “tacking” references heating to the point of softening (but not melting) to effectively join tile preforms to create a single structure. In some cases, minimal compression is applied for tacking. The preform charge, which is often created in a special fixture, conforms to the shape of the mold (and hence the part), or portions of it. Because the resin in the preforms is not heated to liquefication (the preforms are typically heated to a temperature that is above the heat deflection temperature of the resin, but below the melting point), and the applied pressure is typically low (less than 100 psig and in some cases nothing more than tile force of “gravity” acting on the preforms), the preform charge is not fully consolidated and thus could not function as a finished part. Importantly, the preforms within the preform charge substantially maintain their individually and form, and hence their fiber alignment. But once joined in this fashion, the preforms will not move. Thus, the preform charge is a (very nascent) version of the part, and exhibits the fiber alignment (based on the specific alignment/orientation of the preforms therein) desired in the final part. See, e.g., Publ. Pat. Apps. US2020/0114596 and US2020/0361122.

As used herein, the term “assemblage of preforms” refers to either a lay-up of preforms, as formed by placing preforms one-by-one into a mold cavity, or to a preform charge.

As previously noted, a preform, as that term is used herein, is a bundle of resin-infused fibers. The individual fibers can have any diameter, which is typically, but not necessarily, in a range of 1 to 100 microns. The individual fibers can have any length, which is application specific, wherein the length results from the cutting operation that creates the associated preform. Individual fibers can include an exterior coating such as, without limitation, sizing, to facilitate processing, adhesion of binder, minimize self-adhesion of fibers, or impart certain characteristics (e.g., electrical conductivity, etc.).

Each individual fiber can be formed of a single material or multiple materials (such as from the materials listed below), or can itself be a composite. For example, an individual fiber can comprise a core (of a first material) that is coated with a second material, such as an electrically conductive material, an electrically insulating material, a thermally conductive material, or a thermally insulating material.

In terms of composition, each individual fiber can be, for example and without limitation, carbon, carbon nanotubes, glass, natural fibers, aramid, boron, metal, ceramic, polymer, synthetic fibers, and others. Non-limiting examples of metal fibers include steel, titanium, tungsten, aluminum, gold, silver, alloys of any of the foregoing, and shape-memory alloys. “Ceramic” refers to all inorganic and non-metallic materials. Non-limiting examples of ceramic fiber include glass (e.g., S-glass, E-glass, AR-glass, etc.), quartz, metal oxide (e.g., alumina), alumina silicate, calcium silicate, rock wool, boron nitride, silicon carbide, and combinations of any of the foregoing. Non-limiting examples of suitable synthetic fibers include nylon (polyamides), polyester, polypropylene, meta-aramid, para-aramid, polyphenylene sulfide, and rayon (regenerated cellulose).

Any resin -thermoplastic or thermoset- that bonds to itself under heat and/or pressure can be used in conjunction with embodiments of the invention.

Exemplary thermoplastic resins useful in conjunction with embodiments of the invention include, without limitation, acrylonitrile butadiene styrene (ABS), ethylene tetrafluoroethylene (ETFE), fluorinated ethylene propylene (FEP), liquid crystal polymers (LCPs), polyamides (Nylon), polyaryletherketones (PAEK), polybenzimidazole (PBI), polybutylene terephthalate (PBT), polycarbonates (PC), and polycarbonate-ABS (PC-ABS), polyethylene (PE), polyetheretherketone (PEEK), polyetherimide (PEI), polyether sulfones (PES), polyethylene terephthalate (PET), perfluoroalkoxy copolymer (PFA), polyimide (PI), polymethylmethacrylate (PMMA), polyoxymethylene (polyacetals) (POM), polypropylene (PP), polyphosphoric acid (PPA), polyphenylene ether (PPE), polyphenylene oxide (PPO), polyphenylene sulfide (PPS), polyphenylsulfone (PPSU), Polystyrene (PS), polysulfone (PSU), polytetrafluoroethylene (PTFE), polyurethane (PU), polyvinyl chloride (PVC), styrene acrylonitrile (SAN), and styrene butadiene styrene (SBS). A thermoplastic can be a thermoplastic elastomer such as polyurethane elastomer, polyether ester block copolymer, styrenic block copolymer, polyolefin elastomer, polyether block amide, thermoplastic olefins, elastomeric alloys (TPE and TPV), thermoplastic polyurethanes, thermoplastic copolyesters, thermoplastic polyamides, and thermoplastic silicone vulcanizate.

Non-limiting examples of suitable thermosets include araldite, bakelites, epoxies, melamines, phenol/formaldehydes, polyesters, polyhexahydrotriazines, polyimides, polyisocyanates, polyureas, silicones, urea/formaldehydes, vinyl esters, phenolics, and polycarbonates. Suitable thermosets can be prepared as a partially cured B-stage,

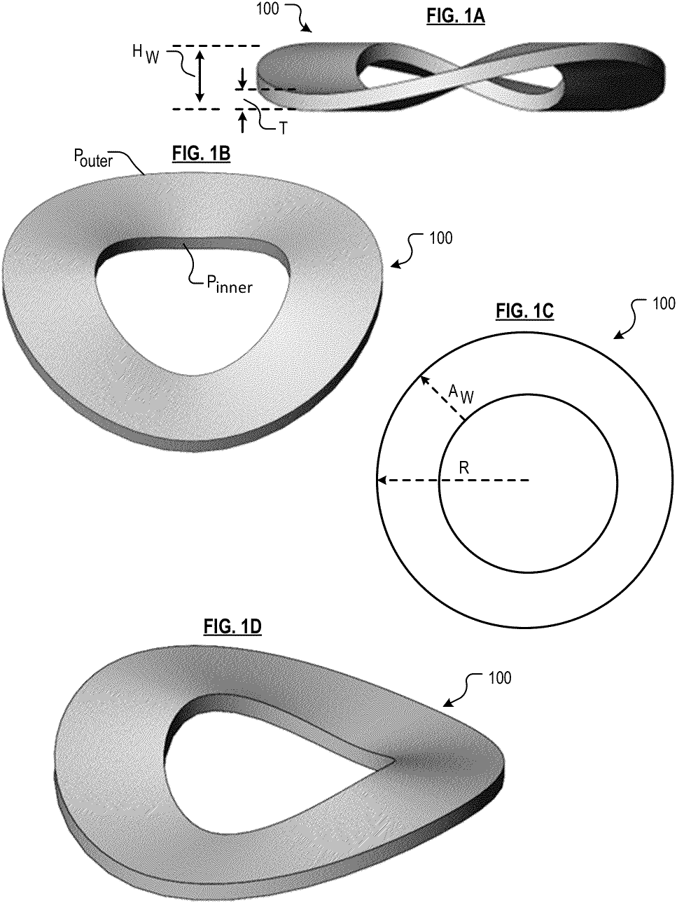

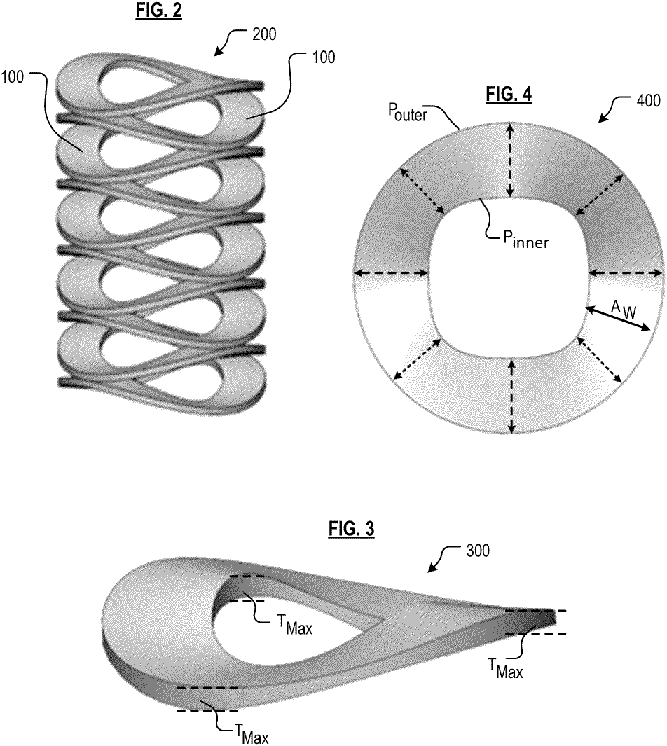

Wave Springs Having Annular Wave-Spring Elements. FIGS. 1A -1D depict annular wave spring element 100 in accordance with the present invention. FIG. 1A depicts a side perspective view, FIGS. 1B and 1D, wherein FIG. 1D is rotated 45 degrees relative to FIG. 1B, and FIG. 1C depicts a plan view of annular wave-spring element 100.

Annular wave-spring element 100 has a continuous circular design with an undulating height profile. Many attributes/characteristics of an annular wave-spring element can be customized to generate a desired stiffness behavior, such as, without limitation: vertical height Hw (i.e., wave height), vertical thickness T (constant or varied), radius R (constant or varied), annular width Aw (constant or varied), period of undulation (i.e., wave frequency), shape of inner perimeter Pᵢₙₙₑᵣ and outer perimeter Pₒᵤₜₑᵣ (individually selected from: circular, polygonal, symmetric, asymmetric, or otherwise customized), material selection (including both resin and reinforcing fiber), and fiber volume fraction.

A “wave spring” in accordance with the present teachings includes at least one, and typically more than one, wave-spring element, which (in the case of a wave spring having annular wave-spring elements) are positioned one “above” the next in a vertical array or stack. That is, the wave-spring elements are arranged so that they are coextensive. The stack need not be vertically oriented in use. FIG. 2 depicts wave spring 200 having ten annular wave-spring elements 100.

As depicted in greater detail in later figures, in accordance with the present teachings, the individual annular wave-spring elements in a wave spring are not rigidly coupled to one another. Among other benefits, this facilitates fabrication of a wave spring in which the properties of individual wave-spring elements may vary, such as in any one or more of the attributes disclosed above, thereby providing the ability to create a wave spring with a response characteristic that is highly tuned to the intended use case.

For instance, consider a wave spring in accordance with the present teachings that includes ten of annular wave-spring elements 100 depicted in FIGS. 1A-1D. Each wave-spring element 100 may have a slightly different thickness T from the others. For example, consider such a wave spring in which the “topmost” annular wave spring element has constant thickness “X” and each successive element is 3% thicker than the element “above” it. The “bottommost” wave-spring element will thus be about 34 percent thicker than the topmost element, and correspondingly significantly stiffer.

As this particular wave spring is compressed, the relatively less-stiff upper annular wave-spring elements will initially compress to a greater degree than the relatively stiffer lower annular wave-spring elements. The force profile of the wave spring will therefore be determined to a relatively larger degree by the upper annular wave-spring elements. As the stroke proceeds, the spring compresses, wherein the relatively thicker bottom annular wave-spring elements will provide greater resistance per unit of stroke length than is experienced at the beginning of the stroke. The wave spring thus provides a progressive spring rate, which is desirable in a variety of applications.

In other embodiments, the stiffness through the “layers” of the wave spring is customized by varying fiber volume fraction (FVF) from wave-spring element to wave-spring element. For example, in the illustrative ten-element wave spring referenced above, consider an embodiment in which the FVF of the uppermost annular wave-spring element is 0.3 and the FVF of the lowermost annular wave-spring element is 0.6. This also results in a progressive spring stiffness throughout the wave spring’s stroke. The variation in FVF (between the uppermost and lowermost annular wave-spring elements) can be linear or non-linear.

FIG. 3 depicts annular wave-spring element 300 having a varying thickness; thickness is at a maximum, Tₘₐₓ, at the lowest and highest regions of the annular wave-spring element. This would result in a wave-spring element having different properties than a wave-spring element having a constant thickness.

FIG. 41 depicts annular wave-spring element 400, wherein the shape of the inner perimeter and the shape of the outer perimeter differ; inner perimeter Pᵢₙₙₑᵣ defines a rounded square, wherein outer perimeter Pₒᵤₜₑᵣ is circular. The annular width A_{w} of annular wave-spring element 400 is relatively shorter near the rounded corners of the inner perimeter than near its midpoints (i.e., the dotted lines are shorter than the dashed lines). Consequently, annular wave-spring element 400 will be relatively less stiff at these radially shorter regions. Note that the top and bottom of the “wave” coincide with such midpoints.

Progressive spring rates can be useful, for example, in protecting machinery or other objects from crashes or other unanticipated impact loads. Impulsive accelerations imparted on an object during an event such as a crash can be tens or hundreds of times greater than acceleration due to gravity. If a spring rate is too low, particularly in a high-acceleration event such as a crash, the spring can bottom out and the sprung object can be exposed to impulse loads that can cause severe damage to an object or even destroy it. A progressive spring rate will enable the spring to mitigate higher loads without letting the spring bottom out and become impulsive.

Wave springs can also be made to have a regressive spring rate such that they provide less resistance as they are compressed. For instance, this can be useful for taking up “slop” in machinery or when dealing with higher-than-normal impact loads in vehicle suspensions. For machinery, the regressive spring rate provides enough force to keep components within tolerance, but not impart so much force as to disturb alignment or interfere with the operation of the equipment.

As an example, in farm-equipment suspensions, a certain amount of stiffness might be desirable to ensure that an operator’s ride is smooth and equipment does not bounce too much. However, fields are often much more uneven and varied than roads, and bigger-than-average bumps such as large rocks might impart too much force on a tractor or other piece of equipment and potentially cause damage, or upset a towed piece of machinery. A regressive spring will exhibit a certain amount of stiffness until a threshold level of displacement occurs, and will then decrease in stiffness as the displacement increases beyond the threshold. For a tractor or other piece of farm equipment, this will cause the spring to deform, rather than displacing the equipment that it is supporting, preventing the equipment from being rocked or excessively jolted by larger-than-average obstacles.

Traditional metal wave springs are often manufactured as a single piece, such that their spring elements remain properly aligned. For the decoupled annular wave-spring elements described herein, such alignment must be imposed lest the individual annular wave-spring elements rotate relative to one another and “nest.” Nest(ing) refers to when a major surface of an annular wave-spring element is fully in contact with that of another annular wave-spring element. Several approaches for defining and maintaining a proper alignment of the wave-spring elements are described below.

In some embodiments, alignment is maintained in conjunction with a support structure that extends for the length of the stack of annular wave-spring elements. In some of such embodiments, the support structure is disposed within the central opening of each annular wave-spring element. In some of these embodiments, a groove running the length of the support structure receives a projection that extends radially inward from the inner perimeter of each annular wave-spring element. In some other these embodiments, the support structure can include the projections and each annular wave-spring element can include a cooperating channel to receive a projection.

In some other embodiments, the support structure is positioned beyond the outer diameter of each annular wave-spring element. In some of such embodiments, the support structure completely encircles the stack of annular wave-spring elements. In some other of such embodiments, one or more relatively narrower support structures are positioned beyond the outer diameter of the stack of annular wave-spring elements. Each of such support structures couples with each wave element in the manner described above (cooperating grooves and projections).

In some further embodiments, each annular wave-spring element includes at least two holes that receives two support structures that extend the length of the stack of such elements. Still further arrangements, some of which are described later in this specification, and other arrangements that will occur to those skilled in the art in light of the present disclosure, may suitably be used to define and maintain a desired alignment of the annular wave-spring elements. As desired, one or more annular wave-spring elements are decoupled from the cooperating alignment feature, enabling those annular wave-spring elements to “nest,” as may be desired.

Wave springs in accordance with the invention can include plural stacks of annular wave-spring elements.

Although the nesting of annular wave-spring elements can be undesirable in many instances, there are embodiments in which the annular wave-spring elements are intentionally nested. For example, nesting can be used to create a wave spring with a progressive characteristic without requiring the individual annular wave-spring elements to differ from one another.

In some embodiments, the nesting of identical annular wave-spring elements will provide a stack in which stiffness increases in proportion to the number of nested elements. For example, three nested annular wave-spring elements will be thrice as stiff as an identically configured single annular wave-spring element. In addition to simplifying the manufacturing process (since the wave-spring elements can be identical to one another), nesting enables tuning to be accomplished on an ad-hoc basis. That is, a desired number of annular wave-spring elements can be readily nested as desired.

In one embodiment, three nested annular wave-spring elements are positioned above two nested annular wave-spring elements, which are, in turn, positioned above a single annular wave-spring element. The bottommost single annular wave-spring element will deform nominally, the middle group of two nested elements will require twice the force as the single element for the same amount of deformation, and the topmost group of three nested elements will require thrice the force as the single wave-spring element for the same amount of deformation.

Additional methods of creating progressive spring behavior include placing inserts between annular wave-spring elements. In some embodiments, the inserts are placed so that they prevent two annular wave-spring elements from displacing relative to one another once they attain a certain level of displacement. This would increase the spring rate of the pair of the elements and again provide a progressive spring rate. In some embodiments, the inserts are varied in thickness wherein different pairs of annular wave-spring elements attain the maximum allowed displacement relative to one another at different points in the stroke, further providing tunability.

In some embodiments, in addition to the spacers, external rings are used to limit the extent to which single annular wave-spring element or group of elements displace before the load is transferred to the external rings. When used in a nested arrangement described above, the external rings can prevent the single annular wave-spring element from deflecting too much before the two- and three-element groupings begin to deflect and provide resistance.

The preforms from which wave-spring elements (annular or curvilinear) are fabricated can be chosen such that the resin and fibers are transparent to certain electromagnetic (EM) waves such as radio frequency (RF) waves. This would enable the fabrication of wave springs that provide impact absorption for components such as antennae, transmitters, or other signal processing equipment without reducing signal quality.

In some other embodiments, the preforms may comprise resin/fibers that are electrically and/or thermally insulating, which can benefit applications where a sprung mass needs to be electrically or thermally separated from another part or surface. Examples include a wave spring to provide damping to electronics or batteries in a vehicle such as a car, boat, or aircraft.

Wave-spring element Fabrication. An assemblage of preforms is created from which the wave-spring element is fabricated. If prepared outside of the mold cavity, the assemblage is positioned within a mold cavity. The assemblage is arranged so that, at any given position in the mold cavity, the preforms within the assemblage align with the expected principal stress vectors that the wave-spring element will experience under design loads. FIG. 5 depicts an embodiment of preform assemblage 504 (for forming a annular wave-spring element) in mold cavity 502, each line depicting a preform 506. The preforms are arranged concentrically, and in circular fashion, following the curvature of the mold cavity, as required for forming the annular wave-spring element.

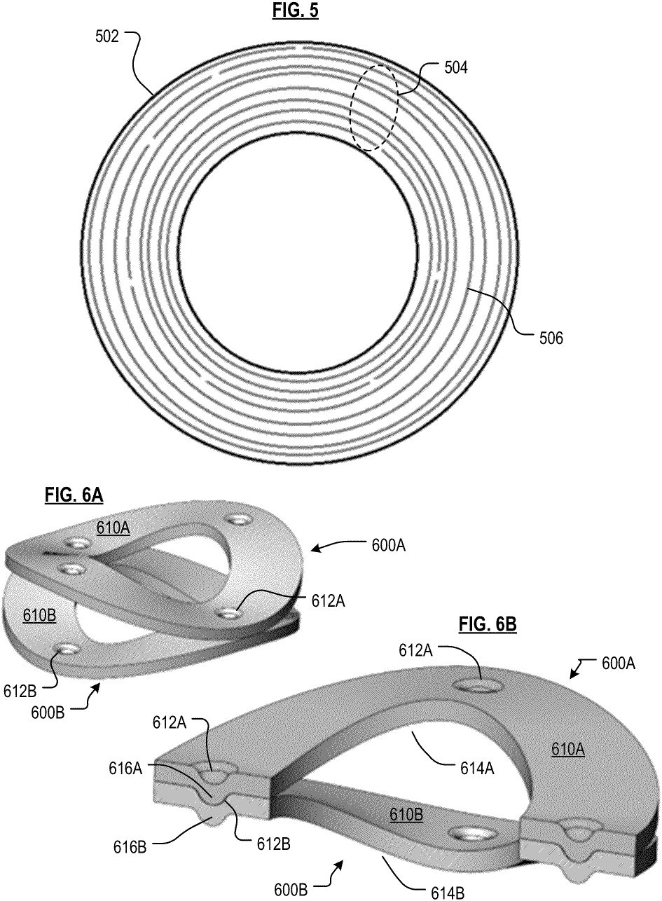

FIGS. 6A, 6B, 7A, 7B, 8A, 8B, 9A-9C, 10A-10E, and 11 depict various embodiments of alignment features for establishing and maintaining proper alignment/registration of the individual annular wave-spring elements in a wave spring.

Annular Wave-Spring Element with Protrusions and Depressions. FIGS. 6A and 6B depict two annular wave-spring elements 600A and 600B. Upper surface 610A of annular wave-spring element 600A include four depressions 612A. Likewise, upper surface 610B of annular wave-spring element 600B include four depressions 612B. Lower surface 614A of annular wave-spring element 600A include four protrusions 616A. Likewise, lower surface 614B of annular wave-spring element 600B include four protrusions 616B. (Only two of the four protrusions are visible, in FIG. 6B, at lower surfaces 614A and 614B of the respective annular wave-spring elements).

Protrusions 616 and depressions 612 are formed in the same position along each annular wave-spring element. That is, the protrusions are directly below the depressions on each annular wave-spring element, and the location of the protrusions/depressions is consistent from annular wave-spring element is across plural elements. This enables the protrusions from an overlying annular wave-spring element to cooperate with a depression from an underlying annular wave-spring element, thus registering such adjacent annular wave-spring elements to one another. An advantage of this embodiment is that no additional pieces are required to couple the annular wave-spring elements to one another.

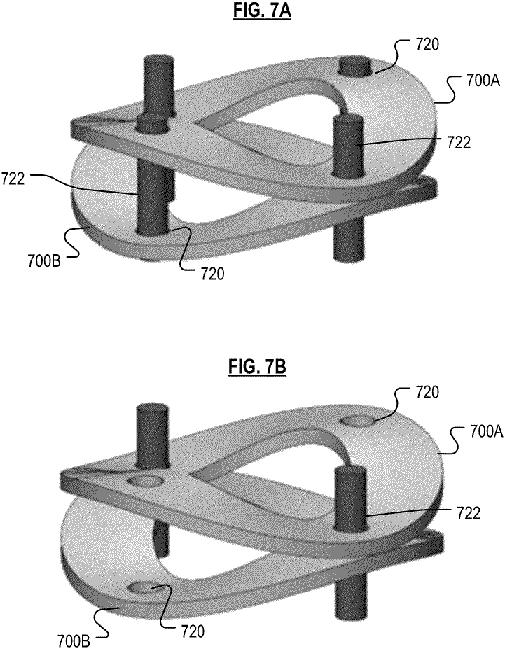

Annular Wave-Spring Element with Holes. FIGS. 7A and 7B depict two annular wave-spring elements 700A and 700B that each include four through-holes 720. Posts 722 are passed through holes 720 to register annular wave-spring elements 700A and 700B to one another and prevent relative rotation of these elements. In FIG. 7A, four posts 722 are used; in FIG. 7B, two posts 722 are used. Of course, in an embodiment in which two posts are to be used, two through-holes 720 rather than four through-holes can be formed in each annular wave-spring element. The use of a single post 722 is insufficient to prevent rotation of the annular wave-spring elements relative to one another. Of course, three posts 722 could be used in conjunction with embodiments of annular wave-spring elements having three or four through-holes. It will be understood that this approach is extendible to large stacks of annular wave-spring elements.

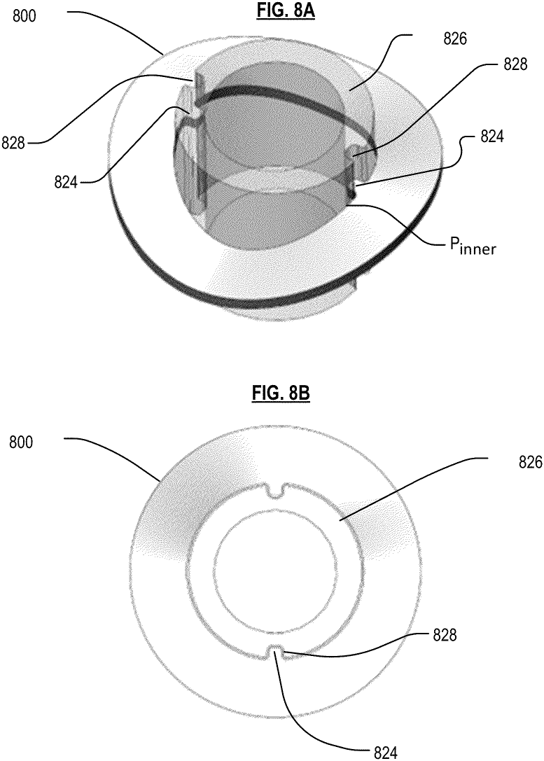

Annular Wave-Spring Element with Radially Extending Protrusions. FIGS. 8A and 8B depict respective perspective and plan views of annular wave-spring element 800 having protrusions 824 that extend radially inward from its inner perimeter Pᵢₙₙₑᵣ. In this embodiment, there are two such protrusions on the annular wave-spring element, diametrically opposed to one another. Protrusions 824 are received by two diametrically opposed keyways or grooves 828 formed in rod 826. In use (for “keying” multiple annular wave-spring elements), rod 826 is positioned within the annular opening of annular wave-spring element(s). This keying arrangement prevents rotation of annular wave-spring element(s). A single protrusion 824 and groove 828 would be sufficient to prevent rotation of wave spring elements. In some other embodiments, the annular wave-spring element includes the keyway(s) and the rod includes the protrusion(s). These figures depict only a single annular wave-spring element for clarity of illustration; it being understood that the purpose of the arrangement is to align multiple annular wave-spring elements. As such, in use, a wave spring configured in this fashion includes a plurality of annular wave-spring elements.

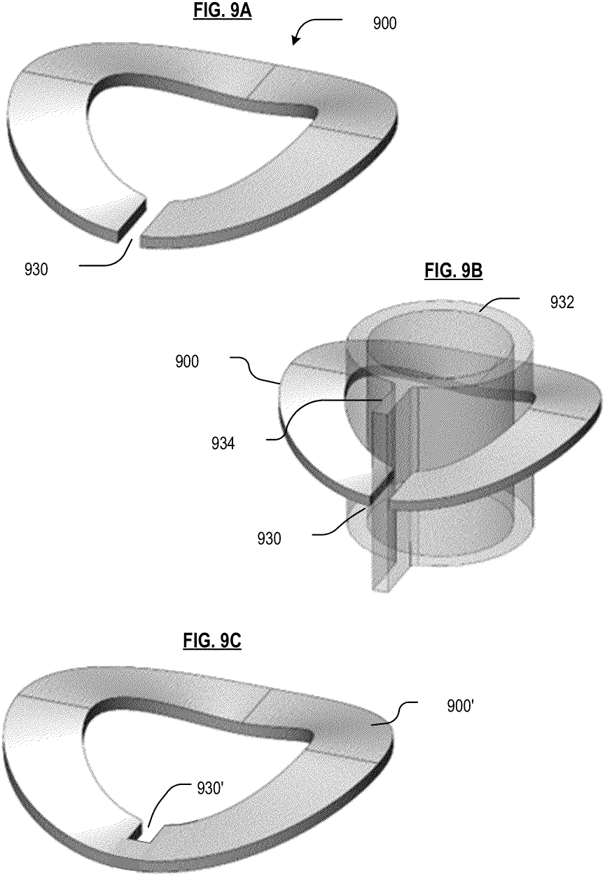

Annular Wave-Spring Element with integrated Keyway. FIG. 9A depicts annular wave-spring element 900 with integrated keyway 930, and FIG. 9B depicts annular wave-spring element 900 in conjunction with rod 932 having a key or protrusion 934 that is received by keyway 930. In this embodiment, keyway 930 extends fully through the annular region of annular wave-spring element 900. In some alternative embodiments, such as depicted in FIG. 9C, keyway 930′ extends only part of the way into the annular region of annular wave-spring element 900′ and couples to a rod (not depicted) with an appropriately shortened protrusion for keying.

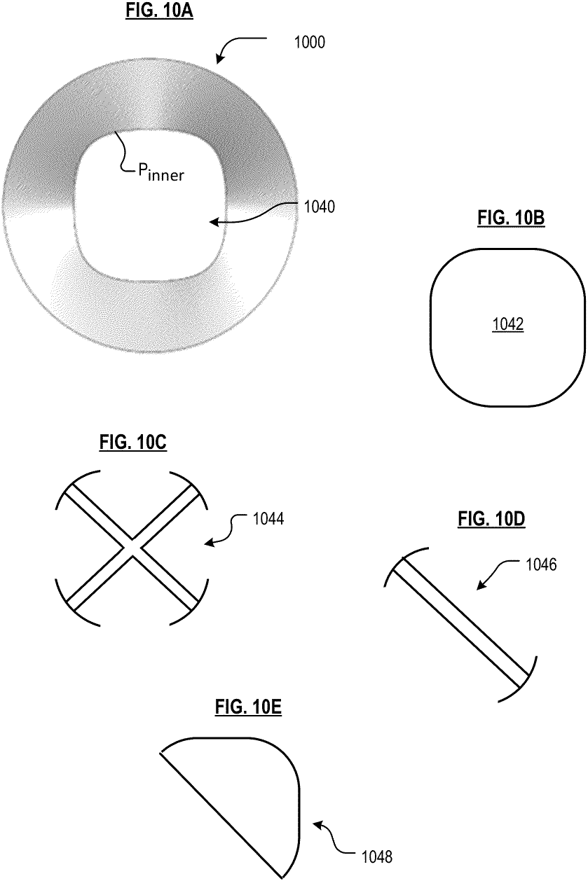

Annular Wave-Spring Element with radially varying inner perimeter. FIG. 10A depicts a plan view of annular wave-spring element 1000 having an inner perimeter Pᵢₙₙₑᵣ that is radially varying or asymmetric. In the depicted embodiment, inner perimeter Pᵢₙₙₑᵣ of annular wave-spring element 1000 has the shape of a square with rounded corners. As will be appreciated by those skilled in the art, a wide variety of radially asymmetric shapes will suffice for the purpose of registering multiple annular wave-spring elements 1000 to one another.

To register a stack of plural annular wave-spring elements 1000 (such as define a wave spring) to one another, a support structure is suitably used. FIGS. 10B through 10E depict, via plan views, a few examples of support structures that, when positioned within opening 1040 of annular wave-spring element 1000, will prevent relative rotation of any annular wave-spring elements to which they couple.

FIG. 10B depicts rod 1042, which has a perimeter that is same shape, but slightly smaller than, inner perimeter Pᵢₙₙₑᵣ of annular wave-spring element 1000. FIG. 10C depicts “x” shaped structure 1044, wherein each one of the four “arms” of the “X” extends to respective ones of the rounded corners of inner perimeter Pᵢₙₙₑᵣ of annular wave-spring element 1000. FIG. 10D depicts linear support structure 1046, wherein each of the two ends of structure 1038 extend to diametrically opposed rounded corners of inner perimeter Pᵢₙₙₑᵣ of annular wave-spring element 1000. And FIG. 10E depicts an approximately triangularly shaped rod 1048, wherein each of the three corners of rod 1048 couples to three rounded corners of inner perimeter Pᵢₙₙₑᵣ of annular wave-spring element 1000.

Annular Wave-Spring Element with Progressive spring rate. FIG. 11 depicts two annular wave-spring elements 1100A and 1100B, each configured to exhibit progressive spring behavior. In this embodiment, this is accomplished by first deforming in torsion, and then deforming in bending. More particularly, each of these annular wave-spring elements is molded so that annular wave-spring element is in some amount of torsion until compressed beyond a designed level of displacement. Note that the cooperating features (i.e., protrusion 1150 on the lower surface of upper annular wave-spring element 1100A and recess 1152 on upper surface of lower annular wave-spring element 1100B are not fully coupled in a quiescent state. In fact, the protrusions and recesses are not axially aligned until annular wave-spring element 1100A compresses to a certain degree. Until an amount of deflection is achieved that causes the features to become axially aligned, the annular wave-spring elements will deform in torsion, but with rather less bending. Once an annular wave-spring element makes full contact with an adjacent element (or other surface), the annular wave-spring element will then deform primarily in bending, such that the spring rate increases.

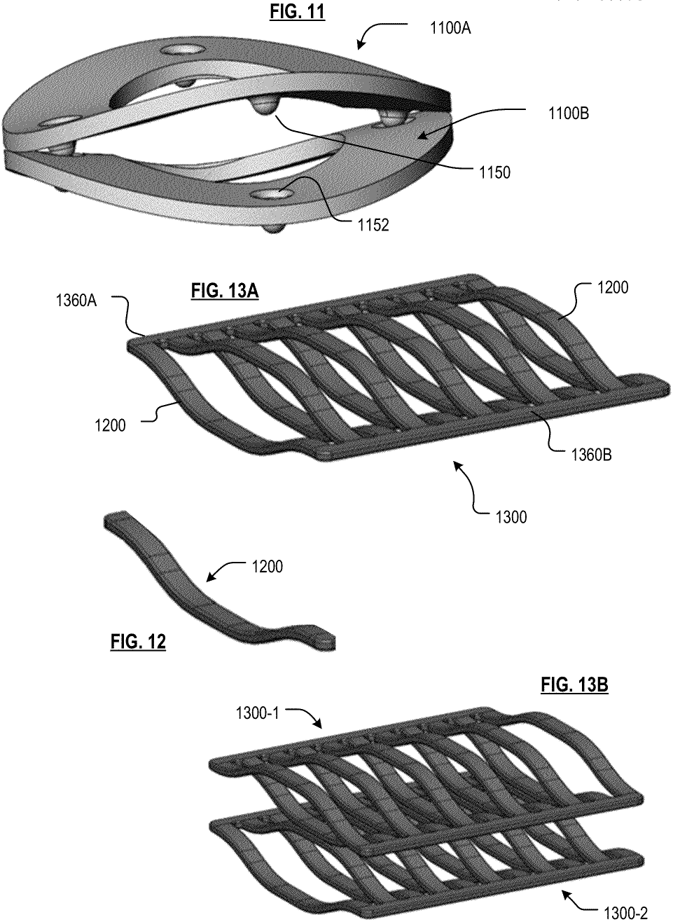

Wave Spring with Curvilinear Wave-Spring Elements. FIG. 12 depicts curvilinear wave-spring element 1200. Like embodiments of an annular wave-spring element, the height of curvilinear wave-spring element 1200 varies along its length, such variation creating one or more “waves” therein. In some embodiments, a wave spring includes one or more of such curvilinear wave-spring elements 1200.

Unlike a wave spring formed from a stack of annular wave-spring elements, a wave spring comprising more than one curvilinear wave-spring element is implemented as a lateral array of such elements. It will be appreciated that for a use case involving a vertically acting force, a wave spring comprising laterally arrayed curvilinear wave-spring elements provides a lower profile than a stack of annular wave-spring elements.

A wave spring comprising one or more curvilinear wave-spring elements can be configured in a variety of ways: (i) all curvilinear wave-spring elements 1200 oriented “curve up” (FIG. 12 depicted element 1200 in a “curve up” orientation), (ii) all curvilinear wave-spring elements 1200 are oriented “curve down,” (iii) some curvilinear wave-spring elements 1200 are oriented “curve up” and others are oriented “curve down.”

In a lateral array of such curvilinear wave-spring elements 1200, if they are all facing the same direction (i.e., all “curve up” or all “curve down”), then the elements are oriented in parallel. In such a wave spring, each element in the array has the same deflection, and the spring rate/force of such a wave spring is equal to the number of curvilinear wave-spring elements times the spring force of an individual element (assuming that all elements have the same characteristics). If all curvilinear wave-spring elements alternate (such as depicted in FIG. 13A), they are in series, and will have a lower spring rate. Thus, the choice of parallel or series arrays depends on spring requirements; parallel for a relatively higher spring rate, series for a lower spring rate.

FIG. 13A depicts wave spring 1300, comprising a lateral array of in-series, curvilinear wave-spring elements 1200. The two ends of each curvilinear wave-spring element 1200 rigidly couple to respective beams 1360A and 1360B. Wave springs comprising lateral arrays of curvilinear wave-spring elements 1200 can be stacked, such as depicted in FIG. 13B, wherein wave springs 1300-1 and 1300-2 are stacked.

In some further embodiments, an array of curvilinear wave-spring elements includes some that are oriented “curve up” and others that are “curve down,” yet not alternating with one another. This provides an ability to tune the spring rate and achieve non-linearity in spring rates.

A wave spring such as wave spring 1300 can be molded in a single open/shut two-piece compression-molding tool. Specifically, molding constituents -an assemblage of fiber-bundle preforms- can be situated in a mold cavity that matches the “curve up” and “curve down” architecture, and uses a matching “plunger” to compress the assemblage.

It is to be understood that the disclosure describes a few embodiments and that many variations of the invention can easily be devised by those skilled in the art after reading this disclosure and that the scope of the present invention is to be determined by the following claims.

What is claimed:

1. A fiber-composite wave spring comprising:
a plurality of wave-spring elements arranged in an array, wherein each wave-spring element consists essentially of aligned fibers in a thermoplastic resin matrix, and wherein the wave-spring elements are one of either: (i) annular wave-spring elements and (ii) curvilinear wave-spring elements, wherein:
A) when the plurality of wave-spring elements are annular wave-spring elements:
(i) the wave spring includes an alignment feature that aligns the annular wave-spring elements to one another; and
(ii) the annular wave-spring elements:
(a) are stacked one above another,
(b) are not rigidly coupled to one another, and interact with the alignment feature;
B) when the plurality of wave-spring elements are curvilinear wave-spring elements:
(i) a first end of each curvilinear wave-spring element is attached to a first member and a second end of each curvilinear wave-spring element is attached to a second member, the plurality of curvilinear wave-spring elements being disposed between the two members; and
(ii) the plurality of wave-spring elements in the array are positioned side by side, the array extending laterally along a length of the first member and second member.

2. The fiber-composite wave spring of claim 1 wherein one or more attributes of the annular wave-spring elements are selected to provide a desired stiffness behavior, wherein the attributes are selected from the group consisting of wave height, thickness of the annular wave-spring element, variability of thickness of the annular wave-spring element, shape of inner perimeter of the annular wave-spring element, shape of an outer perimeter of the annular wave-spring element, wave frequency, a distance between the inner perimeter and the outer perimeter of the annular wave-spring element, variability of a distance between the inner perimeter and the outer perimeter of the annular wave-spring element, resin composition, fiber composition, and fiber volume fraction.

3. The fiber-composite wave spring of claim 1 wherein a value of one or more attributes of some of the annular wave-spring elements of the plurality differ from a value of the one or more attributes of other of the annular wave-spring elements of the plurality.

4. The fiber-composite wave spring of claim 1 wherein when the plurality of wave-spring elements are annular wave-spring elements, the alignment feature includes at least one rod to which the plurality of annular wave-spring elements couple.

5. The fiber-composite wave spring of claim 1 wherein one or more of the annular wave-spring elements is configured to exhibit progressive spring behavior by first deforming in torsion until compressed beyond a design level of displacement, and then deforming in bending.

6. The fiber-composite wave spring of claim 1 wherein the plurality of curvilinear wave-spring elements in the array are all oriented in the same direction, either all curve-facing-down or all curve-facing-up.

7. The fiber-composite wave spring of claim 1 wherein an orientation of curvilinear wave-spring elements in the array alternates between curve facing down and curve facing up.

8. A fiber-composite wave spring comprising:
a plurality of annular wave-spring elements arranged in an array, wherein each of the annular wave-spring elements consist essentially of aligned fibers in a thermoplastic resin matrix, and wherein:
(a) the annular wave-spring elements are not rigidly coupled to one another;
(b) the annular wave-spring elements are stacked one above another; and
an alignment feature that aligns the wave-spring elements to one another.

9. The fiber-composite wave spring of claim 8 wherein one or more attributes of the annular wave-spring elements are selected to provide a desired stiffness behavior, wherein the attributes are selected from the group consisting of wave height, thickness of the annular wave-spring element, variability of thickness of the annular wave-spring element, shape of inner perimeter of the annular wave-spring element, shape of an outer perimeter of the annular wave-spring element, wave frequency, a distance between the inner perimeter and the outer perimeter of the annular wave-spring element, variability of a distance between the inner perimeter and the outer perimeter of the annular wave-spring element, resin composition, fiber composition, and fiber volume fraction.

10. The fiber-composite wave spring of claim 8 wherein a value of one or more attributes of some of the annular wave-spring elements of the plurality differ from a value of the one or more attributes of other of the annular wave-spring elements of the plurality.

11. The fiber-composite wave spring of claim 8 wherein the alignment feature includes at least one rod to which the plurality of annular wave-spring elements couple.

12. The fiber-composite wave spring of claim 8 wherein one or more of the annular wave-spring elements is configured to exhibit progressive spring behavior by first deforming in torsion until compressed beyond a design level of displacement, and then deforming in bending.

13. A fiber-composite wave spring comprising:
a plurality of curvilinear wave-spring elements arranged in an array, wherein each wave-spring elements consists essentially of aligned fibers in a thermoplastic resin matrix, and wherein:
a first end of each curvilinear wave-spring element is attached to a first member and a second end of each curvilinear wave-spring element is attached to a second member, the plurality of curvilinear wave-spring elements being disposed between the two members; and
the plurality of curvilinear wave-spring elements in the array are positioned side by side, the array extending laterally along a length of the first member and second member.

14. The fiber-composite wave spring of claim 13 wherein the plurality of curvilinear wave-spring elements in the array are all oriented in the same direction, either all curve facing down or all curve facing up.

15. The fiber-composite wave spring of claim 13 wherein an orientation of curvilinear wave-spring elements in the array alternates between curve facing down and curve facing up.
